(19) United States
(12) Patent Application Publication
(10) Pub. No.: US 2016/0019730 A1
(43) Pub. Date: Jan. 21, 2016

(54) REMOTE ONBOARD EMISSION COMPLIANCE TECHNIQUE

(71) Applicant: Nexus Environmental, LLC, Miami Beach, FL (US)

(72) Inventor: Pradeep R. Tripathi, Miami Beach, FL (US)

(21) Appl. No.: 14/867,318

(22) Filed: Sep. 28, 2015

Related U.S. Application Data
(63) Continuation-in-part of application No. PCT/US14/32505, filed on Apr. 1, 2014.
(60) Provisional application No. 61/807,147, filed on Apr. 1, 2013.

(51) Int. Cl. G07C 5/00; G07C 5/08

(52) U.S. Cl. CPC G07C 5/008; G07C 5/085; G07C 5/0808

(57) ABSTRACT

A vehicle emission compliance or operational diagnostic data retrieval system and method for use with a vehicle equipped with an onboard diagnostic system, according to an aspect of the invention, includes a remote data collection system that is adapted to read and store vehicle emission data from the onboard diagnostic system and is programmed to determine whether the remote data collection system has a connection with a central server and to transmitting the read vehicle emission data with the remote data collection system if it is determined that the remote data collection system has a connection with the central server. The remote data collection system is further adapted to hold the read vehicle emission data at the remote data collection system if it is determined that the remote data collection system does not have a connection with the central server.

### CROSS REFERENCE TO RELATED APPLICATIONS

This application is a continuation-in-part of International Patent Cooperation Treaty

Application No. PCT/US2014/032505 filed on Apr. 1, 2014, which claims priority to U.S. provisional patent application Ser. No. 61/807,147 filed Apr. 1, 2013, the disclosures of which are hereby incorporated herein by reference in their entirety.

### BACKGROUND OF THE INVENTION

The present invention is directed to a vehicle emission compliance system and method for use with a vehicle equipped with an onboard diagnostic system (OBD) and in particular to a remote OBD system and method that does not require a physical presence of the vehicle at a test facility to perform annual emission compliance certification.

Known remote OBD systems use various techniques for communicating data retrieved from the OBD system of the vehicle, such as for emission testing of the vehicle to verify that the vehicle is in compliance with EPA emission standards. However, such known systems have drawbacks that add to the cost of the system beyond the relatively minor cost of the remote OBD device installed in the vehicle. Such additional costs may be a result of recurring communication charges, such as incurred by cellular communication charges. Alternatively, such additional costs may be the result of the need to build dedicated infrastructure charges to be able to retrieve OBD data without recurring communication charges.

### SUMMARY OF THE INVENTION

The present invention provides a remote vehicle data collection technique that does not require communication charges and does so without the expense of building dedicated infrastructure. The invention can be used for emission compliance verification, vehicle operational condition diagnosis, and the like.

A vehicle emission compliance or operational diagnostic data retrieval system and method for use with a vehicle equipped with an onboard diagnostic system, according to an aspect of the invention, includes a remote data collection system that is adapted to read and store vehicle emission data from the onboard diagnostic system and is programmed to determine whether the remote data collection system has a connection with a central server and to transmitting the read vehicle emission data with the remote data collection system if it is determined that the remote data collection system has a connection with the central server. The remote data collection system is further adapted to hold the read vehicle emission data at the remote data collection system if it is determined that the remote data collection system does not have a connection with the central server.

The data collection system may have a wireless network interface, and the central server may be connected with the interface. The determining may include verifying connection of the wireless network interface with a local area network and that the local area network has connection with the Internet. The data collection system may include an OBD interface link and a mobile computing device having the network interface. The remote data collection system may be adapted to determine whether the remote data collection system has a WIFI connection with a local area network. The remote data collection system may be adapted to determine whether the mobile computing device is available for receiving communication from the OBD interface link. The OBD interface link may be adapted to retain the vehicle emission data at the OBD interface link if the mobile computing device is not available for communicating read vehicle emission data from the interface. A Bluetooth connection may be used between the OBD interface device and the mobile computing device to communicate the read vehicle emission data to the mobile computing device.

The identification numbers of the vehicle, the OBD interface device and the mobile computing device may be examined to determine if such identification numbers belong together. The identification number of the vehicle may be a VIN or vehicle specific OBD data. The identification number of the mobile computing device may be a telephone number, a MAC address, or the like. The identification number of the OBD interface device may be a serial number or a MAC address, or the like.

The central server, which is accessed over the Internet via the local area network, may be adapted to process data received from the remote data collection system and update the remote data collection system in response to the processed data. The server may be adapted to process data including performing statistical analysis. The server may be adapted to perform trending analysis to determine whether a specific vehicle or type of vehicle requires change in OBD data collected or method of analysis. The server may be adapted to process data including fraud detection. The remote data collection system may include an OBD interface link application and a mobile computing device application and be adapted to update the OBD interface link application and mobile computing device application through the mobile computing device. The OBD interface link, mobile computing device and server may be adapted to read and store vehicle emission data and update the remote data collection system in response to the processed data repeatedly in an iterative cycle.

### BRIEF DESCRIPTION OF THE DRAWINGS

FIG. 1 is a block diagram of a vehicle diagnostic system according to an embodiment of the invention;

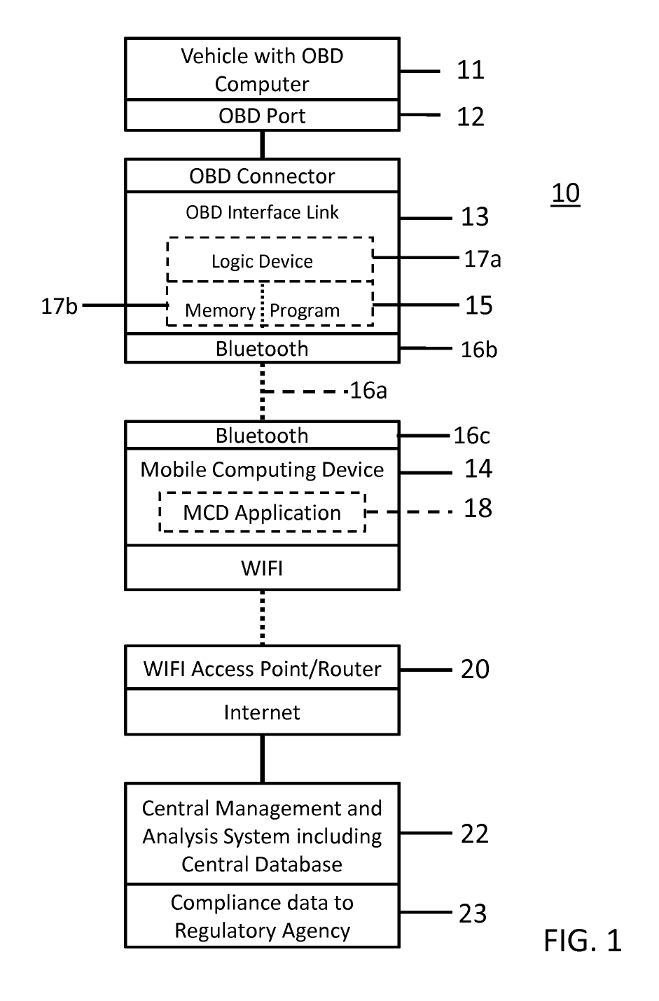

FIG. 2 is a logic flow diagram of a method of obtaining vehicle emission data using the system in FIG. 1;

FIG. 3 is the same view as FIG. 1 of an alternative embodiment thereof;

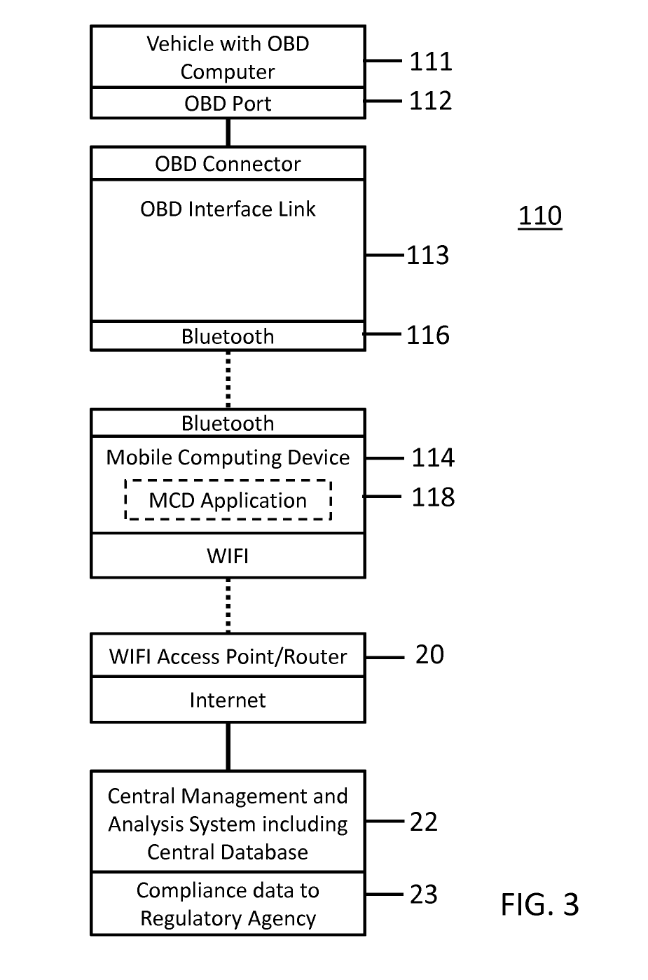

FIG. 4 is a logic flow diagram of a method of obtaining vehicle emission data using the system in FIG. 3;

FIG. 5 is a block diagram of a centralized system incorporating a plurality of vehicle remote data collection systems; and

FIG. 6 is a logic flow diagram of a dynamically adaptive process carried out by the system in FIG. 5.

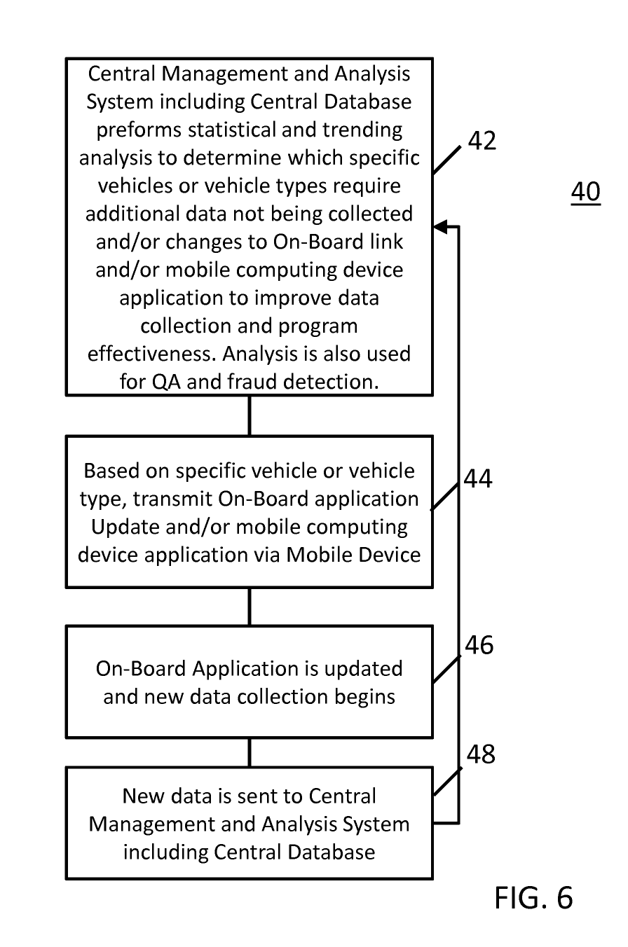

### DESCRIPTION OF THE PREFERRED EMBODIMENT

Referring now to the drawings and the illustrated embodiments depicted therein, a vehicle emission compliance verification system 10 is for use with a vehicle (not shown) equipped with an onboard diagnostic system 11 having a diagnostic port 12. Diagnostic system 10 includes an OBD interface link 13 that is configured to connect with diagnostic port 12 of onboard diagnostic system 11 and to read emission data from onboard diagnostic system 11. Emission compliance verification system 10 further includes a communication channel 16 that is established between interface device 13 and a mobile computing device 14, such as a conventional cellular telephone device, such as a smart phone, tablet media player, or the like. Communication channel 16a is configured to communicate the diagnostic data read by the OBD interface link 13 to mobile computing device 14. Communication channel 16a is illustrated embodied in a wireless communication interface, such as a Bluetooth connection 16b. To accomplish such a connection, interface link 13 has a Bluetooth communication circuit 16b that is configured to communicate with the Bluetooth communication circuit 16c in mobile computing device 14. Interface link 13 will additionally include a logic circuit 17a, such as a programmed microprocessor, or the like, memory 17b that stores data, an onboard link application 15 that is configured to read data from diagnostic port 12 and operate its Bluetooth communication circuit 16a to communicate the data to the mobile computing device Bluetooth circuit 16c. The configuration of such programmed processor 17a and Bluetooth circuit 16b would be well within the ability of the average skilled artisan. Mobile computing device 14 is conventional and could be a hand-held device, such as a “Smart” phone, media player, “Tablet” computer, or the like, that is available from a number of suppliers. Either way, mobile computing device 14 would be normally carried by the user and forms no portion of the invention, per se.

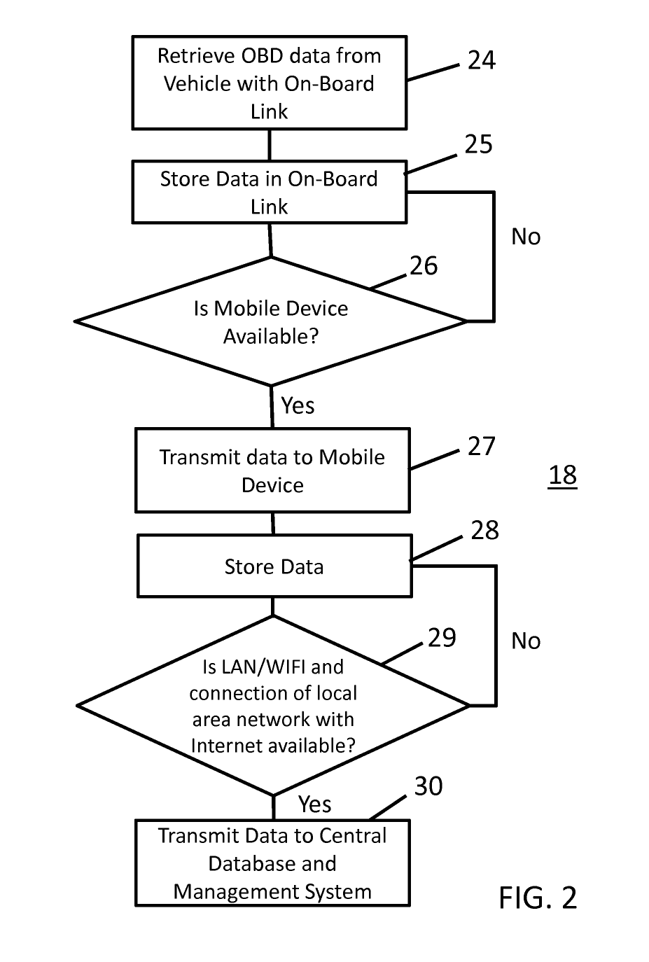

OBD interface link 13 includes a logic device 17a, such as a microprocessor, programmable digital array or other programmable device, a digital memory device 17b and an application program 15 that would reside in memory device 17b of link 13. A computer program 18 resides in conventional memory on mobile computing device 14. Either or both programs could be downloaded and updated through mobile computing device 14, such as by a Smartphone application, or the like. Program 15 causes data either continuously, or on some regular basis, to be downloaded from an OBD port of OBD computer 11 and stored in memory device 17b whether mobile computing device 14 is in communication with link 13 or not. Computer program 18 controls mobile computing device 14 to carry out the logic shown in FIG. 2.

Referring to FIG. 2, program 15 is configured to retrieve OBD data from OBD Port 12 at 24 and to store at least the emission data of the retrieved OBD data in memory 17b at 25. Program 18 then determines at 26 whether a recognized mobile computing device 14 is in Bluetooth connection with interface link 13. A mobile computing device may belong to someone else operating the vehicle, but not have the emission data application necessary to retrieve emission data from OBD link 13 or may not be a recognized component of system 10. Thus, data will be stored in interface link 13 and transferred only to a recognized mobile computing device. Also, a Bluetooth communication channel will only be intermittently maintained. There may be other Bluetooth devices onboard the vehicle that may need to communicate with mobile device 14. Therefore, a communication connection with interface link 13 will only be intermittent and only if interface link recognizes mobile computing device 14, such as by its Bluetooth pairing, phone number, MAC address, or other identification number.

Program 18 then transmits data to mobile computing device 14 at 27 if available as previously described where the data is stored on device 14 at 28. Program 18 then determines at 29 whether mobile computing device 14 has a connection with a local area network, such as a wireless network WIFI hotspot 20 and whether the hotspot has connection with the Internet. Program 18 may use a conventional feature of mobile computing device 14 to detect a wireless network hotspot 20 and a connection of the hotspot with the Internet and verify that communication with the wireless network hotspot is established and the hotspot connected with the Internet. When program 18 determines at 29 that communication has been established with wireless hotspot 20 and the Internet, then it causes mobile computing device 14 to transmit at 30 the read vehicle emission data that was stored in the mobile computing device 14 at 28 to the local area network, such as wireless hotspot 20, which then forwards the data to a central database and management system 22 at 30 over the Internet. If it is determined at 29 that no communication connection has been established with a wireless node of a local area network 20 or no connection between local area network 20 and the Internet, then program 18 goes into a holding loop in order to retain the vehicle emission data read and stored at 28 at the mobile computing device.

So, vehicle emission compliance verification system 10 will read OBD data, such as emission data, according to some schedule and stores the data in OBD interface link 13 until it establishes communication with mobile computing device 14 at which time data is transferred to device 14. Data is retained in mobile computing device 14 until device 14 establishes communication with a local area network 20 connected with the Internet. Once it does so, the data may be downloaded via local area network 20 to a central management system 22, which has communication with an emission compliance regulatory agency 23, such as for emission verification or other analysis. Central management system 22 may be a server to which the diagnostic data is sent via the Internet from access point 20. Mobile computing device 14 may be carried by the user to the office or to home when an established connection with a local hotspot is automatically established. Alternatively, the communication may be established at a public venue, such as at a local eatery, or the like. Regardless, the data is retained in mobile computing device 14 and not sent using cellular communication with a cellular network. The use of a cellular network would otherwise result in communication charges of some type at least some of the time, such as roaming charges, data usage charges, or the like. However, use of a local area network, such as a wireless hotspot, allows the OBD data to be downloaded without incurring any additional fees. Thus, even though mobile computing device 14 may be capable of transferring the OBD data by cellular network, it stores the data and transmits the data without substantial communication charges only via a local area network and then only when the local area network is connected with the Internet. In this manner, mobile computing device 14 acts more as a data transport device that transports data from OBD interface link 13 to central management system 22.

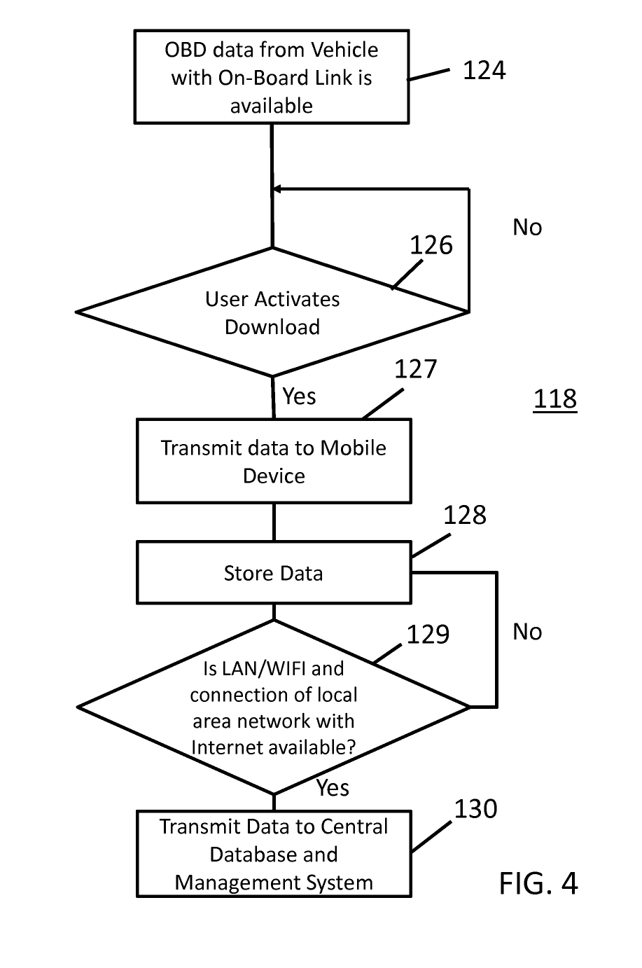

In an alternative embodiment, a vehicle emission compliance verification system 110 includes an OBD interface link 113 having an OBD connector and a Bluetooth interface 16 but no ability to store OBD data. Thus, OBD interface link 113 is capable of interfacing with a mobile computing device 114 but is not capable of storing OBD data. Instead, interface line 113 only downloads OBD data from OBD port on demand. Vehicle emission compliance verification system 110 thereby avoids any concern that OBD data is being accumulated in system 110 where it could be accessed such as in the case of an accident, a speeding infraction, or the like. Thus, any storage of OBD data occurs at the OBD computer 111 which is part of the vehicle and not part of vehicle emission compliance verification system 110. From mobile computing device 114, the OBD data that is captured on-demand can then be communicated with a wireless access point 20 from mobile computing device 114 and from access point 20 the data can be transferred to central management system 22 and regulatory agency 23 for vehicle compliance verification. Mobile computing device 114 runs an application 118 that performs the logic shown in FIG. 4.

Referring to FIG. 4, at least the most recent OBD data is stored by a conventional OBD computer 11 and available at OBD Port 12 at 124. Program 118 then determines at 126 whether a user has selected a data download function, such as the pressing of a button, or other activity that indicates a desire of the user to download vehicle emission data from OBD computer 11. The user could be the motorist, an inspector that is performing an annual emission inspection on the vehicle emission control system or a mechanic diagnosing a problem with the vehicle emission control system by determining the state of the OBD data or a user wishing to have the OBD data of the vehicle analyzed. If no data download selection is made to a data download at 126, then the program cycles through a loop until it is determined at 126 that a data download is selected. The program then downloads data at 127 to mobile-computing device 14 and stores the data at 128 in the memory of device 114 provided that device 114 is a recognized mobile-computing device and is in Bluetooth connection with interface link 113, as previously described with respect to system 10. The mobile-computing device may belong to someone else operating the vehicle, but not have the diagnostic application necessary to retrieve data from OBD link 113 or may not be a recognized component of system 10. Thus, data will be transferred only to a recognized mobile-computing device. Also, a Bluetooth communication channel will only be intermittently maintained. There may be other Bluetooth devices onboard the vehicle that may need to communicate with mobile device 14. Therefore, a communication connection with interface link 113 will only be intermittent and only if the interface link recognizes mobile-computing device 114, such as by Bluetooth pairing, its phone number or other identification number.

Program 118 then determines at 129 whether mobile-computing device 114 has a connection with a local area network, such as a wireless network WIFI hotspot 20 and the local area network has a connection with the Internet. Program 118 may use a conventional feature of mobile-computing device 114 to detect a wireless network hotspot 20 and verify that communication with the wireless network hotspot is established and use conventional technology to sense a connection of the local area network with the Internet. When program 18 determines at 129 that communication has been established with wireless hotspot 20 and connection of the local area network with the Internet, then it causes mobile computing device 114 to transmit at 130 the vehicle emission data that was stored in the mobile computing device at 128 to the local area network, such as wireless hotspot 20, which forwards the data to a central database and management system 22 over the Internet. If it is determined at 129 that no communication connection has been established with a wireless node of a local area network 20, or no connection of local area network 20 with the Internet, then program 118 goes into a holding loop in order to retain the diagnostic data read and stored at 128 at the mobile-computing device.

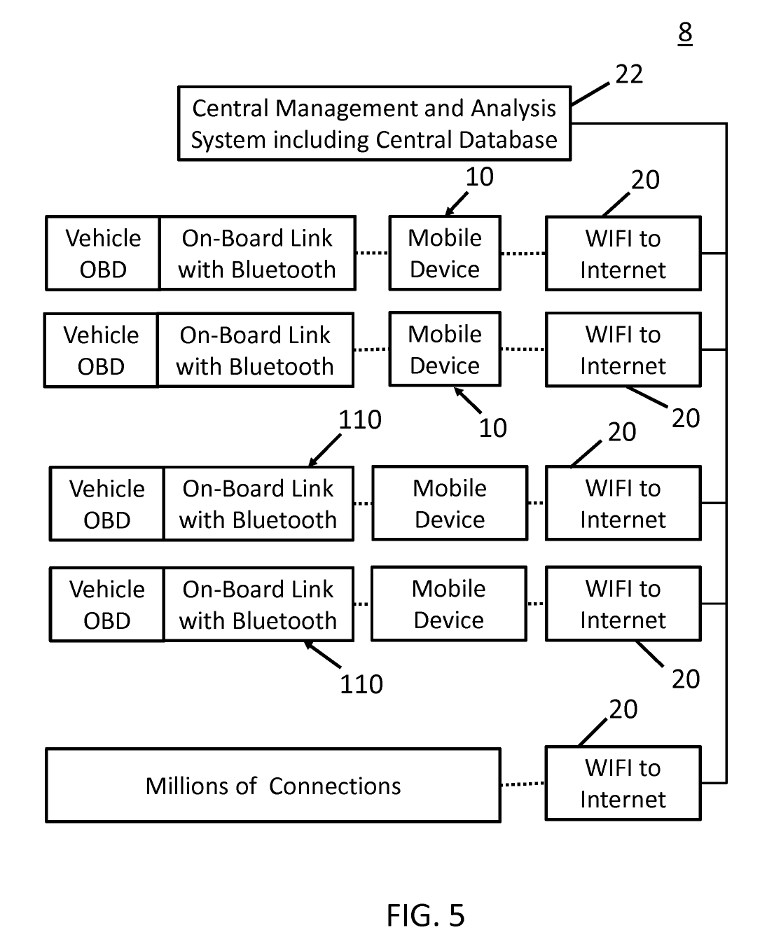

As can be seen in FIG. 5, a large number of both onboard diagnostic systems 10 and onboard diagnostic systems 110 can be combined in a centralized system 8, such as for an environmental clearance agency. Central management and analysis system 8 may include a central database 22 capable of performing statistical and trending analysis to determine a particular vehicle of class of vehicles, such as a certain model number, that requires additional data not being collected by system 10, 110. Also, system 22 may determine a desire to improve data collection for overall program effectiveness. System 22 performs statistical trending analysis at 42 and transmits through system 8 an onboard link application update and/or a mobile computing device application via mobile computing device 14. Then system 10, 110 begins new data collection with modified parameters at 46. New data is then sent to central management and analysis system 22 at 48. Thus, a dynamically adjustable system is capable of operation in a closed loop to optimize the type of data being collected, the manner of collection, or the like. Also, system 22 may check its database that an appropriate combination of vehicle identification, such as VIN, and vehicle data parameters are similar, the interface link identification, such as serial ID or MAC address, and mobile computing device identification, such as phone number are together. This provides security by avoiding defrauding the emission verification program. Also, statistical analysis may be used to detect other types of fraud. Also, the data collected may be used as a diagnostic tool to determine when the vehicle is in need of maintenance.

While the foregoing description describes several embodiments of the present invention, it will be understood by those skilled in the art that variations and modifications to these embodiments may be made without departing from the spirit and scope of the invention, as defined in the claims below. The present invention encompasses all combinations of various embodiments or aspects of the invention described herein. It is understood that any and all embodiments of the present invention may be taken in conjunction with any other embodiment to describe additional embodiments of the present invention. Furthermore, any elements of an embodiment may be combined with any and all other elements of any of the embodiments to describe additional embodiments.

The embodiments of the invention in which an exclusive property or privilege is claimed are defined as follows:

1. A method of obtaining vehicle emission compliance or operational diagnostic data of a vehicle equipped with an onboard diagnostic system over an Internet, said method comprising:
reading vehicle emission data from the vehicle onboard diagnostic system with a remote data collection system, wherein said remote data collection system has a wireless network interface;
determining whether said remote data collection system has a connection with a central server, said central server connected with the Internet, wherein said determining comprises verifying connection of the wireless network interface with a local area network and that the local area network has connection with the Internet;
if it is determined that the remote data collection system has a connection with the central server, then transmitting the read diagnostic device to the central server; and
if it is determined that the remote data collection system does not have a connection with the central server, then holding the read diagnostic data at said remote data collection system.

2. The method as claimed in claim 1 wherein said verifying connection with a local area network includes verifying that said remote data collection system has a WIFI wireless connection to a local area network.

3. The method as claimed in claim 1 wherein remote data collection system comprises an OBD interface link for reading and storing the vehicle emission data and a mobile computing device for receiving the vehicle emission data from the OBD interface link and having the wireless network interface.

4. The method as claimed in claim 3 including determining that said mobile computing device is available for receiving communication from said OBD interface link.

5. The method as claimed in claim 4 including communicating read diagnostic data from said interface link if it is determined that said mobile computing device is available and retaining diagnostic data at said interface link if said mobile computing device is not available.

6. The method as claimed in claim 4 including determining whether a user selects that OBD data be downloaded and communicating vehicle emission data from said interface link if the user selects that OBD data be downloaded and retaining vehicle emission data at the onboard diagnostic system if the user does not select that OBD data be downloaded.

7. The method as claimed in claim 4 including storing the vehicle emission data communicated from the interface link at the mobile computing device.

8. The method as claimed in claim 4 wherein said communicating the read vehicle emission data to the mobile computing device comprises using a Bluetooth connection between said OBD interface link and said mobile computing device.

9. The method as claimed in claim 3 including examining identification numbers of the vehicle, the OBD interface link and the mobile computing device to determine if such identification numbers belong together.

10. The method as claimed in claim 9 wherein the identification number of the vehicle is a VIN or vehicle specific OBD data.

11. The method as claimed in claim 9 wherein the identification number of the mobile computing device comprises a telephone number or a MAC address of the mobile computing device.

12. The method as claimed in claim 9 wherein the identification number of the OBD interface link comprises a MAC address or a serial number of the OBD interface link.

13. The method as claimed in claim 1 including processing data received by the central server and updating the remote data collection system in response to the processing data.

14. The method as claimed in claim 13 wherein said processing data includes performing statistical analysis.

15. The method as claimed in claim 14 wherein said processing data includes performing trending analysis to determine whether a specific vehicle or type of vehicle requires change in OBD data collected or method of analysis.

16. The method as claimed in claim 13 wherein said processing data includes fraud detection.

17. The method as claimed in claim 3 wherein the remote data collection system comprises an OBD interface link application and a mobile computing device application and including updating the OBD interface link application and mobile computing device application through the mobile computing device.

18. A vehicle emission compliance or operational diagnostic data system for use with a vehicle equipped with an onboard diagnostic system and an Internet, said system comprising:
a central server connected with the Internet;
a remote data collection system that is configured to read vehicle emission data from the onboard diagnostic system wherein said remote data collection system has a wireless network interface; and
a program that determines whether said remote data collection system has a connection with a central server; and
said remote data collection system transmitting the read vehicle emission data to the central server if said program determines that the remote data collection system has a connection with the central server, wherein said program determines that said remote data collection system has a connection with said central server by determining that said remote data collection system has a connection with a local area network and said local area network has a connection with the Internet, said program further adapted to hold the read vehicle emission data at said remote data collection system if it is determined that the remote data collection system does not have a connection with the central server.

19. The system as claimed in claim 18 wherein said program is adapted to determine whether said remote data collection system has a WIFI connection with the local area network.

20. The system as claimed in claim 18 wherein remote data collection system comprises an OBD interface link for reading and storing the vehicle emission data and a mobile computing device for receiving the vehicle emission data from the OBD interface link and having the wireless network interface.

21. The system as claimed in claim 20 wherein said program determines whether said mobile computing device is available for receiving communication from said OBD interface link.

22. The system as claimed in claim 21 wherein said OBD interface link is adapted to retain the diagnostic data at said interface link if said mobile computing device is not available for communicating read diagnostic data from said interface.

23. The system as claimed in claim 21 including a Bluetooth connection between said OBD interface link and said mobile computing device that is adapted to communicate the read diagnostic data to the mobile computing device.

24. The system as claimed in claim 21 wherein said program determines whether a user selects that OBD data is to be downloaded and communicates emission compliance data from said interface link if the user selects that OBD data is to be downloaded and does not retain diagnostic data at the interface link if the user does not select that OBD data is to be downloaded.

25. The system as claimed in claim 24 wherein said mobile computing device stores the emission compliance data communicated from the OBD interface link.

26. The system as claimed in claim 25 wherein said program examines identification numbers of the vehicle, the OBD interface link and the mobile computing device to determine if such identification numbers belong together.

27. The system as claimed in claim 26 wherein the identification number of the vehicle is a VIN or vehicle specific OBD data.

28. The system as claimed in claim 26 wherein the identification number of the mobile computing device comprises a telephone number or a MAC address of the mobile computing device.

29. The system as claimed in claim 26 wherein the identification number of the OBD interface link comprises a MAC address or a serial number of the OBD interface link.

30. The system as claimed in claim 18 wherein said remote data collection system is adapted to send the emission data to the central server that processes data received from the remote data collection system and updates the remote data collection system in response to the processed data.

31. The system as claimed in claim 30 wherein said central server processes data including performing statistical analysis.

32. The system as claimed in claim 31 wherein said central server processes data including performing trending analysis to determine whether a specific vehicle or type of vehicle requires change in vehicle emission data collected or method of analysis.

33. The system as claimed in claim 30 wherein said central server is adapted to process data including fraud detection.

34. The system as claimed in claim 30 wherein the remote data collection system comprises an OBD interface link application and a mobile computing device application and is adapted to update the OBD interface link application and mobile computing device application through the mobile computing device.

35. The system as claimed in claim 30 wherein OBD interface link and said central server are adapted to read and store vehicle emission data and update the OBD interface link application and mobile computing device application in response to the processing data are repeatedly performed in an iterative cycle.
